(19) United States
(12) Patent Application Publication
(10) Pub. No.: US 2023/0050124 A1
(43) Pub. Date: Feb. 16, 2023

(54) VENTILATED TOILET

(71) Applicant: Franklin Lanza, Kirtland Hills, OH (US)

(72) Inventor: Franklin Lanza, Kirtland Hills, OH (US)

(21) Appl. No.: 17/398,647

(22) Filed: Aug. 10, 2021

(51) Int. Cl. E03D 9/052

(52) U.S. Cl. CPC E03D 9/052

(57) ABSTRACT

A ventilated toilet includes a bowl with a rim including a rim conduit with a plurality of flush apertures that open to the bowl. A drain conduit communicates with a waste outlet of the bowl and includes a stack outlet for communicating with an associated waste stack. A trap is located in the drain conduit between the waste outlet of the bowl and the stack outlet of the drain conduit for containing liquid that blocks airflow through said drain conduit. A neck is located adjacent the rim of the bowl and includes a neck conduit in communication with the rim conduit. A water tank is connected to the neck and includes an internal space for holding water that is in communication with the neck conduit. A lid covers an open upper end of the tank. A flush valve is located in the tank and selectively opens to allow flow of water from the internal space of the tank to the neck conduit. An overflow tube is in communication with the neck conduit and includes an open upper end that is located above a water level of the internal space of the tank. An exhaust blower includes a blower inlet and a blower outlet. A blower inlet conduit connects the blower inlet to the internal space of said tank, and the blower inlet conduit includes an open upper end that is located above the water level such that the open upper end of the blower conduit is spaced-apart from the open upper end of the overflow tube. The blower outlet is in communication with the drain conduit downstream from the trap between the trap and the stack outlet. A check valve is located between the blower outlet and the drain conduit for preventing odorous air from flowing upstream into the blower outlet, wherein said check valve is adapted to selectively open when said exhaust blower is activated.

### BACKGROUND

The present disclosure relates to a toilet. More particularly, the present disclosure relates to a toilet including a ventilation system for exhausting odorous air therefrom. The present disclosure is supplemental to existing U.S. Pat. No. 8,695,123 B2 and is authored by the existing patent holder, and the entire disclosure of said U.S. Pat. No. 8,695,123 is hereby expressly incorporated by reference into the present disclosure.

It is apparent that numerous innovations for toilets have been provided in the prior art that are adapted to be used. Furthermore, even though these innovations may be suitable for the specific individual purposes to which they address, however, they would not be suitable for the purposes of the present disclosure as described herein.

### BRIEF SUMMARY

The present disclosure provides a method for exhausting odorous air from a toilet that avoids the disadvantages of the prior art and is simple to use.

The present disclosure provides a toilet for exhausting odorous air therefrom, comprising a bowl, a trap, a self-contained ventilation system, a water tank, and a water supply line. The bowl has a rim therearound wherein the bowl communicates with the rim. The bowl is for receiving human waste that produces the odorous air. The main trap is contained in or located adjacent the bowl, wherein the trap is for communicating the contents in the bowl with a drain conduit so as to provide a passageway from the bowl to a drain stack. The ventilation system includes an exhaust blower having a blower inlet and a blower outlet. The blower inlet is in communication with air space between the contents in the bowl and the rim. The blower outlet is in communication with the drain conduit downstream from the trap. The exhaust blower further includes a check valve between the blower outlet and the drain conduit for preventing the odorous air from flowing upstream from the drain stack into the blower outlet. The check valve is spring biased to a closed position and when closed blocks the odorous air from the drain conduit to the blower outlet. The check valve is selectively biased to an open position when the exhaust blower is activated at a pressure at the blower outlet thereby opening the check valve to allow odorous air to flow from the blower outlet to the drain conduit.

The present disclosure further provides a toilet for exhausting odorous air therefrom, comprising a bowl, a trap, a self-contained ventilation system, a water tank, a water tank seal, an air allowance valve/check valve, and a water supply line. The bowl has a rim therearound wherein the bowl communicates with the rim. The bowl is for receiving human waste that produces the odorous air. The main trap is contained in or located adjacent the bowl wherein the trap is for communicating the contents in the bowl with a drain conduit so as to provide a passageway from the bowl to a drain stack. The ventilation system includes an exhaust blower having a blower inlet and a blower outlet. The blower inlet is in communication with air space between the contents in the bowl and the rim. The blower outlet is in communication with the drain conduit downstream from the trap. The air allowance valve can open during flush to relieve the vacuum created in the tank during blower operation allowing contents of tank to empty down into the bowl.

In accordance with another aspect of the present disclosure, a ventilated toilet includes a bowl with a rim including a rim conduit with a plurality of flush apertures that open to the bowl. A drain conduit communicates with a waste outlet of the bowl and includes a stack outlet for communicating with an associated waste stack. A trap is located in the drain conduit between the waste outlet of the bowl and the stack outlet of the drain conduit for containing liquid that blocks airflow through said drain conduit. A neck is located adjacent the rim of the bowl and includes a neck conduit in communication with the rim conduit. A water tank is connected to the neck and includes an internal space for holding water that is in communication with the neck conduit. A lid covers an open upper end of the tank. A flush valve is located in the tank and selectively opens to allow flow of water from the internal space of the tank to the neck conduit. An overflow tube is in communication with the neck conduit and includes an open upper end that is located above a maximum water level of the internal space of the tank. An exhaust blower includes a blower inlet and a blower outlet. A blower inlet conduit connects the blower inlet to the internal space of said tank, and the blower inlet conduit includes an open upper end that is located above the maximum water level such that the open upper end of the blower conduit is spaced-apart from the open upper end of the overflow tube. The blower outlet is in communication with the drain conduit downstream from the trap between the trap and the stack outlet. A check valve is located between the blower outlet and the drain conduit and is adapted to selectively open when said exhaust blower is activated.

The novel features which are considered characteristic of the present disclosure are set forth in the appended claims. The disclosure itself, however, both as to its construction and its method of operation, together with additional objects and advantages thereof, will be best understood from the following description of the specific embodiments when read and understood in connection with the accompanying drawing.

### BRIEF DESCRIPTION OF THE DR AWINGS

The figures of the drawing are briefly described as follows:

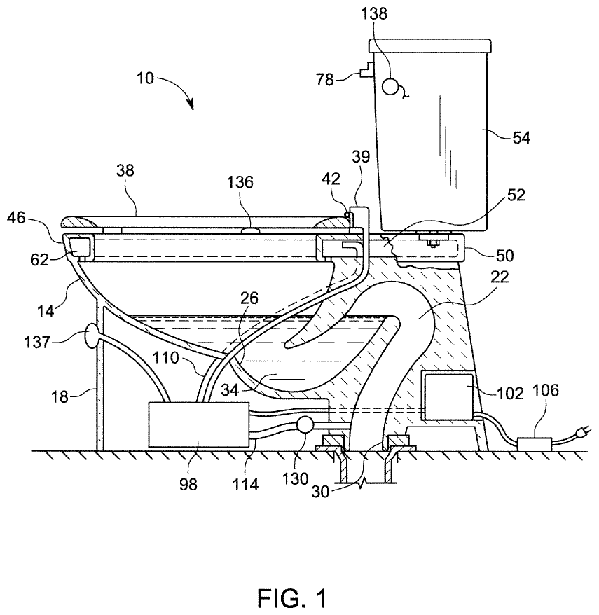

FIG. 1 is an enlarged diagrammatic cross-sectional view of a toilet assembly;

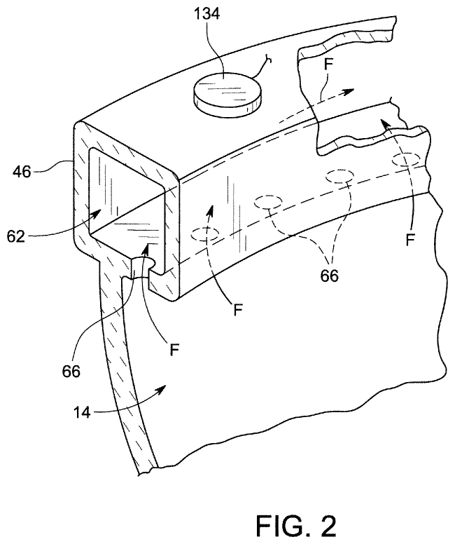

FIG. 2 is an enlarged cross-sectional view of a portion of a toilet bowl and rim;

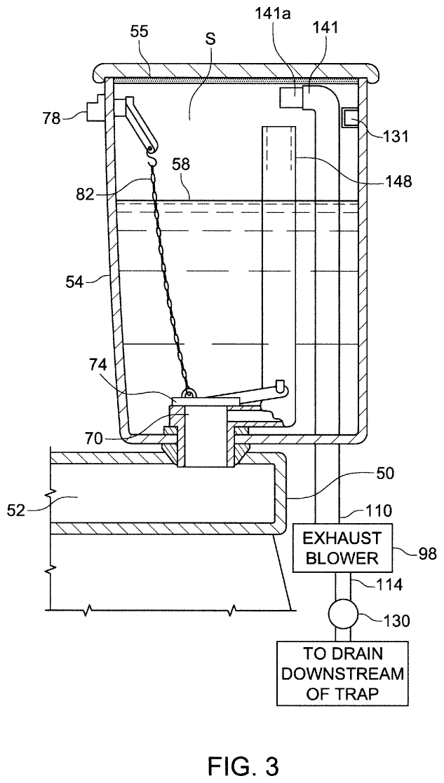

FIG. 3 is a cross sectional side view of a toilet tank and adjacent portions of the toilet neck and neck conduit;

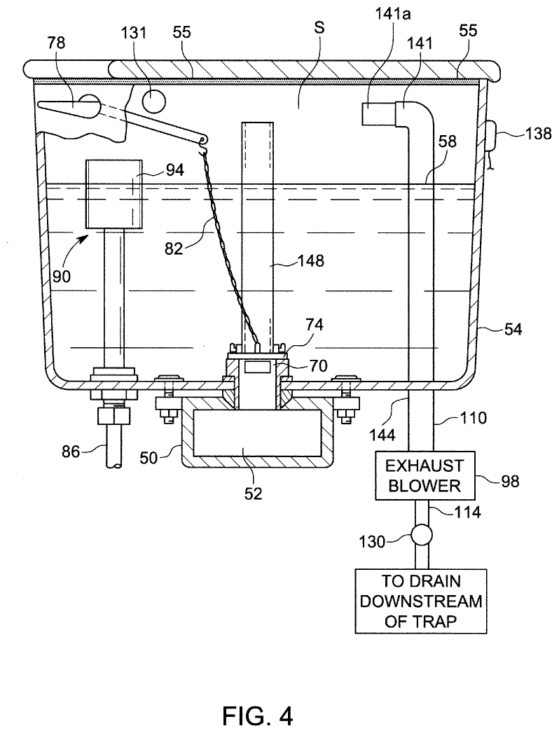

FIG. 4 is a cross sectional front view of the toilet tank and adjacent portions of the toilet neck and neck conduit; and,

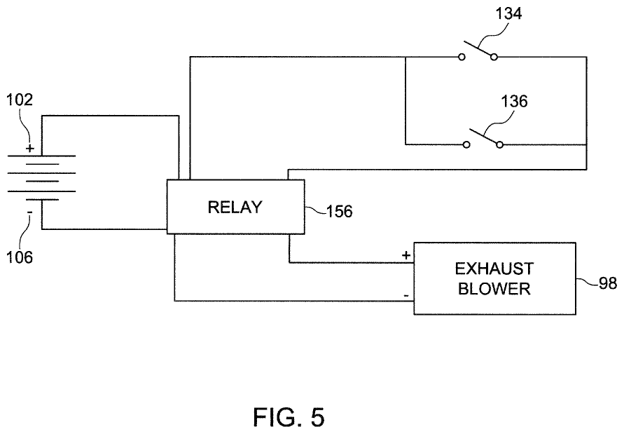

FIG. 5 is an electrical circuit schematic according to one embodiment of the present disclosure.

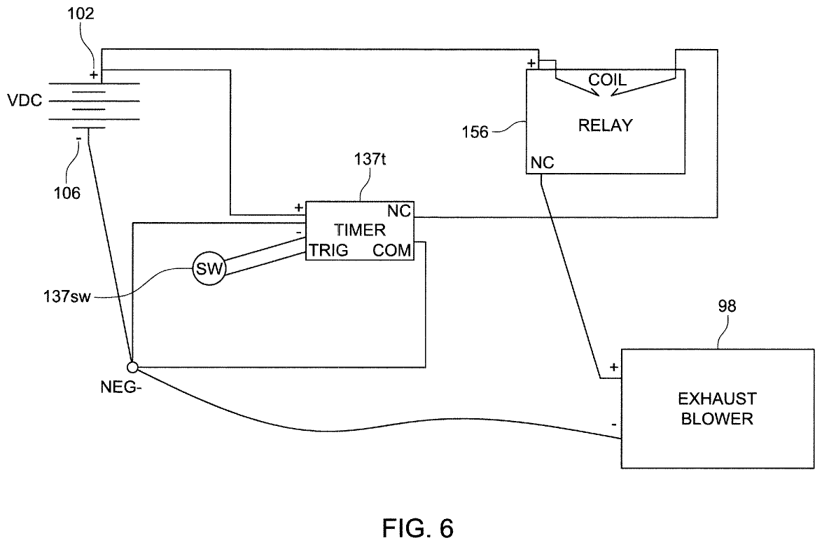

FIG. 6 is an electrical circuit schematic according to one embodiment of the present disclosure.

### DETAILED DESCRIPTION

Referring now to the figures, in which like numerals indicate like parts, and particularly to FIG. 1, which is a diagrammatic cross-sectional view of the present disclosure, the toilet assembly of the present disclosure is shown generally at 10 for exhausting odorous air (see arrows F described below) therefrom. The configuration of the toilet assembly 10 can best be seen in FIG. 1, which is a diagrammatic cross-sectional view of the toilet 10, and as such, will be discussed with reference thereto. It will be understood that each of the elements described above, or two or more together, may also find a useful application in other types of constructions differing from the types described above. While the disclosure has been illustrated and described as embodied in a toilet for exhausting odorous air therefrom, however, it is not limited to the details shown, since it will be understood that various omissions, modifications, substitutions and changes in the forms and details of the device illustrated, and its operation can be made by those skilled in the art without departing in any way from the spirit of the present disclosure. Without further analysis, the foregoing will so fully reveal the gist of the present disclosure that others can, by applying current knowledge, readily adapt it for various applications without omitting features that, from the standpoint of prior art, fairly constitute characteristics of the generic or specific aspects of this disclosure.

The present development relates to a self-contained ventilated toilet assembly 10 as illustrated in FIGS. 1-6. The toilet 10 includes a bowl 14 defined as part of a pedestal base 18. The pedestal base 18 defines a drain conduit 22. The drain conduit 22 begins at a waste outlet 26 that communicates with the bowl 14 and extends to a stack outlet 30 that is adapted to communicate with a conventional drain stack of a house or other structure (not shown) in which the toilet is installed. The drain conduit 22 comprises a trap 34 downstream from the bowl 14 that collects a volume of water to block flow of sewage gases from the drain stack into the bowl 14 by way of the drain conduit 22. A ring or U-shaped toilet seat 38 is pivotally connected to the pedestal base 18 by a hinge 42 and generally conforms to the dimensions of a rim 46 of the bowl so as to provide a seating location for a user of the toilet 10.

The pedestal base 18 defines a neck 50 adjacent the rim 46 that extends horizontally outward from the rim 46 of the bowl 14 at the rear of the rim/bowl. A tank 54 is supported on/above the neck 50 and includes an internal space that is adapted to contain a volume of water 58 that is selectively communicated to the bowl 14 for supplying water and flushing waste from the bowl through waste outlet 26, into the drain conduit 22, and out of the drain conduit 22 via stack outlet 30 into the drain stack. The water 58 is shown at its maximum operational water level which represents the maximum level or water present in the tank 54 during normal operation of the toilet 10. More particularly, the rim 46 of the bowl defines an internal rim conduit 62 as shown in FIGS. 1 and 2. A lower region of the rim conduit 62 includes a plurality of apertures 66 that communicate with the bowl. During a flush of the toilet 10, water 58 from the tank 54 flows into a neck conduit 52 of the neck 50 which communicates with the rim conduit 62 such that the water 58 flows from the neck conduit 52 into the rim conduit 62. Water flowing in the rim conduit 62 flows out of the apertures 66 into the bowl 14 such that the contents of the bowl 14 are flushed into the drain conduit 22 via waste outlet 26. The water 58 is shown at its maximum water level such that an air space S is always present inside the tank 54 between the water 58 and the lid that closes the open upper end of the tank 54.

As shown in FIGS. 3 and 4, the tank 54 comprises a flush opening 70 that is in fluid communication with the neck conduit 52 (which is in fluid communication with the rim conduit 62). A flush valve 74 is located in the tank 54 and normally seats over the flush opening 70 to block same. The flush valve 74 (e.g., a flapper or other type of valve) is selectively unseated by user manipulation of a flush handle 78, which is connected to the flush valve 74 by a linkage such as a chain 82 or other member(s). When the flush valve 74 is unseated, water 58 in the tank 54 flows by gravity (or alternatively assisted by air admittance valve 131) into the flush opening 70, neck conduit 52, rim conduit 62 and rim apertures 66 for flushing the bowl 14 as described above. When the user releases the handle 78, the flapper or other flush valve 74 is normally re-seated over the flush opening 70 to block same.

As shown in FIG. 4, the tank 54 is connected to a water supply line 86, and a float valve 90 is located in the tank 54 and controls the flow of water 58 into the tank 54 to refill same after a flush. In particular, the float valve 90 comprises a float 94 that moves up and down with the level of water 58 in the tank 54. When the level of water 58 in the tank drops during a flush, the float 94 drops and opens the float valve 90 to allow a flush, the float 94 drops and opens the float valve 90 to allow flow of water into the tank 54 from the supply line 86. When the valve 74 closes and the level of the water 58 in the tank 54 rises to a select level, the float 94 is elevated sufficiently to close the float valve 90 to stop the flow of water into the tank via supply line 86.

Unlike a conventional toilet, the toilet 10 comprises a self-contained ventilation system to evacuate noxious gases from the bowl 14. In the illustrated embodiment, the self-contained ventilation system can be automatically activated when a user of the toilet 10 is seated on the toilet seat 38, but alternative activation systems are contemplated, such as a manual on/off switch, or timed switch 137, connected to the toilet 10. The toilet 10 comprises an exhaust fan or exhaust blower 98 comprising an electrically operated fan housed in the pedestal base 18 (or alternatively mounted outside the pedestal base). The exhaust blower 98 is electrically connected to a low-voltage source of electrical power. The blower 98 can be provided in many configurations without departing from the scope of the present invention. In one non-limiting example, the blower includes a 5-inch to 6-inch body diameter that fits nicely within the pedestal base 18, and the blower can create 20 inches to 24 inches of water static pressure and/or 35 cubic feet per minute (CFM) to 42 cubic feet per minute (CFM) of airflow when operative.

In one example, the low-voltage source of electrical power comprises a rechargeable battery 102 (e.g., 12 volts) that can be also housed in, or around, the pedestal base 18. The battery 102 can be removable for recharging and/or can be adapted to be recharged by selectively connecting the pedestal base 18 to a source of electrical power. In another example, the toilet 10 comprises a DC power supply 106 (alone or in combination with the battery) that is connected to a conventional wall outlet for input of AC electrical power and output of DC electrical power, e.g., 12 to 24 volts DC to the exhaust blower 98. In either case, when the exhaust blower 98 is activated, it draws air and other gases into its blower inlet 110 and exhausts same through its blower outlet 114.

According to the present development, the blower inlet 110 is in communication with the interior of the bowl 14 (i.e., generally the space in the bowl 14 between the top of the rim 46 (above) and any water or other contents of the bowl (below), and the blower outlet 114 is in communication with the drain conduit 22 downstream from the trap 34 (i.e., at a location in the drain conduit 22 preferably between the trap 34 and stack outlet 30 where gases flowing into the drain conduit 22 from the blower outlet 114 will not be able to flow back to the bowl 14 via the drain conduit 22). The blower inlet 110 and/or blower outlet 114 can communicate with various locations of the toilet 10 as described herein via conduits such as flexible metal or polymeric conduits and/or via conduits or other passages that are formed as part of the toilet 10 such as being made part of the porcelain or other structure that defines the bowl 14, pedestal base 18, neck 50, and/or other part of the toilet 10. In one embodiment as shown in FIG. 1, the blower inlet 110 is in communication with the rim conduit 62 (directly or via the neck conduit 52). In such case, the blower inlet 110 is in communication with the interior of the bowl 14 through the rim conduit apertures 66 such that noxious fumes and odors F shown in FIG. 2 are drawn from the bowl 14 into the apertures 66 and rim conduit 62 (and optionally also the neck conduit 52 depending upon the location where the blower inlet 110 is connected to the rim conduit 62 and/or neck conduit 52) and flow to the blower inlet 110 and then to the blower outlet 114 when the exhaust blower 98 is active.

During periods when the exhaust blower 98 is inactive, to prevent noxious sewer gases from flowing upstream from the drain stack and drain conduit 22 into the blower outlet 114, through the exhaust blower 98 and into the bowl 14 by way of the blower inlet 110, the toilet 10 further comprises a check valve 130 located between the blower outlet 114 and the drain conduit 22. The check valve 130 is spring biased to its closed position and, when closed, blocks the flow of sewer gases from the drain conduit 22 to the blower outlet 114. When the exhaust blower 98 is activated, pressure at the blower outlet 114 opens the check valve 130 such that air and odors F can flow from the blower outlet 114 into the drain conduit 22. In one example, the check valve 130 opens in response to a predetermined or select pounds per square inch (PSI) of air pressure. When the blower 98 is deactivated, the check valve 130 automatically returns to its normally closed condition.

The exhaust blower 98 can be operably connected to and controlled by a toggle switch or other manually activated switch 138 located on the toilet or elsewhere such that when the switch 138 is set to “on” the blower 98 is operative to draw air from its inlet 110 to its outlet 114 and when the switch 138 is “off” the blower 98 is inactive (see for example FIGS. 1 and 4 which shows the switch 138 connected to the tank 54). The switch 138 can thus be set to “on” or “off” as desired such as toggle switch. Additionally, or alternatively, a manually activated electronic timer switch 137 may be located on the front of pedestal 18 or elsewhere on the toilet such as on the tank 54. When the timer switch 137 is centrally located on the front of the pedestal 18, it is positioned so as to be located in front of a user seated on the toilet seat 38 and between the user's legs so that the user can reach down and activate the timer switch 137.

In another example, the exhaust blower 98 is automatically activated when a user is seated on the toilet seat 38. As such, the toilet comprises at least one and preferably first and second seat switches 134, 136 (see also FIG. 5) that are connected to the rim 46 and that are located between the rim 46 and toilet seat 38. If multiple switches are used, they are preferably located on opposite lateral sides of the bowl 14 or are otherwise distributed about the rim 46. The switches 134,136 are adapted to be activated (closed) by pressure upon a user being seated on the toilet seat 38. The switches 134,136 are preferably connected in parallel such that the blower 98 is activated if at least one of the switches 134,136 is closed by pressure of a user seated on the toilet seat 38. The one or more switches 134,136 can alternatively be provided as contact or non-contact sensors that use visible or invisible light energy, infrared radiation, an radio-frequency signal, and/or any other suitable contact or non-contact sensor that detects the presence of a user seated on the toilet seat 38 or a user otherwise standing or located near the toilet 10 and that activate the blower 98 when and as long as such a user is detected and, optionally, for a set period of time after the user vacates the toilet seat 38 such as for 30 second, one minute, several minutes, or more or less time as desired. Alternatively, such sensors are activated by the presence of a user near the toilet and/or seated on the toilet seat 38, such that the exhaust blower 98 is activated only when the sensors are activated.

The exhaust blower 98 can be water-compatible and/or submersible such that it is capable of drawing water into the blower inlet 110 and exhausting same via blower outlet 114.

As shown in FIG. 1, the blower inlet 110 can be directly connected to a modified air pass-through hinge/seat flow path 39 located in or adjacent the hinge 42 and/or toilet seat 38 above the rim 46 and in communication with bowl 14 through the open air and/or through a hose or other path that extends from the hinge 42 and/or seat 38 into the bowl, e.g., through a conduit defined in the porcelain or other material from which the pedestal 18 and/or bowl 14 are defined/fabricated and/or through a separate conduit. In one example of such an embodiment, the hinge 42 and or seat 38 comprise one or more flow-paths 39 defined therein that are in communication with the blower inlet 110 through a conduit that is separate from and/or defined as part of the pedestal 18 and/or bowl 14 such that the odors F are drawn from the bowl 14 an into the flow paths 39 that are integrated into the hinge 42 and/or seat 38 and flow to the blower inlet 110. In one non-limiting example, this embodiment can be used for toilets that do not have a water tank 54, although this embodiment can also be used for a toilet having a water tank 54 such as the toilet 10.

Alternatively, as shown in FIG. 4, the blower inlet 110 is connected through a blower inlet conduit 141 to an open upper portion the tank 54 which is in communication with the open-air space S located between the water 58 and a lid 54L that closes the open upper end or top of the tank 54. In the illustrated example, the blower inlet conduit 141 includes a lower end 144 that projects outwardly through the tank 54 through a sealed water-tight opening below the water 58 and that is connected to the blower inlet. The conduit 141 thus is communication with the neck conduit 52, rim conduit 62, and rim conduit apertures 66 by way of an overflow tube 148 that includes an open upper end 152 that extends above the water 58 in the tank 54 (above the maximum water level of the tank 54) and that includes a lower end that is in communication with the neck conduit 52. A rubber, felt, polymeric, foam, and/or other tank seal 55 is located between the lid 54L and the tank 54 to ensure that air is not drawn into the tank 54 by the blower 98 between the lid and the tank 54 in a manner that would prevent the blower 98 from exerting sufficient negative pressure on the open upper end of the overflow tube 148. The seal 55 limits the amount of air to be drawn into the blower inlet 110 between the lid and the tank 54. Because the overflow tube 148 is in communication with the neck conduit 52, the blower inlet 110 will also be in communication with the neck conduit 52, rim conduit 62, and rim conduit apertures 66, via conduit 141,144 connected to the blower inlet 110.

It should be noted that the open upper end 141a of the blower inlet conduit 141 provides an inlet to the conduit 141 that communicates with the blower inlet 110 and that is located in the space S is spaced above the water 58 and spaced away from the open upper end of the overflow tube 148 such that water 58 from the tank and water admitted by the float valve 90 will not undesirably be drawn into the blower inlet 110. The open upper end 141a of the blower inlet conduit 141 indirectly communicates with the open upper end of the overflow tube 148 through the open space S since the blower inlet conduit 141 is spaced-apart from and disconnected from the open upper end of the overflow tube 148. The open upper end 141a of the blower inlet conduit 141 can be adjusted or otherwise selectively extendable toward and selectively rotating away from said open upper end of the overflow tube 148 to vary the open distance between said open upper end 141a of said blower inlet conduit 141 and said open upper end of said overflow tube 148 which can increase or decrease the suction or vacuum established by the blower 98 at the open upper end of the overflow tube 148 as well as provide access to flush valve assembly for maintenance or replacement purposes.

An air admittance valve/check valve 131 is connected to and extends through the tank 54 and/or through the tank lid to selectively allow air to flow into the tank from a surrounding atmosphere located outside the tank 54 to prevent an excessive vacuum condition within the tank in the space S as could interfere with the gravitational flushing of the toilet 10. The air admittance valve/check valve 131 is normally closed or restricted to prevent or minimize air admittance into the space S from outside the tank 54 to ensure that the blower 98 is able to develop sufficient negative pressure at its inlet 110 to draw odors F from the bowl 14 as described. The air admittance valve/check valve 131 selectively opens to allow airflow into the space S from outside the tank when a sufficient pressure differential develops between the space S inside the tank 54 and the atmosphere located outside the tank 54. Preferably, operation of the blower 98, itself, does not cause a sufficient pressure differential to develop as would cause the air admittance valve to open. In one example, the air admittance valve 131 comprises a polymeric valve structure including one or more resilient polymeric flaps that normally obstruct airflow but that can be selectively opened by a pressure differential thereacross so as to allow enough airflow to complete the gravitational flushing operation.

As noted above, any hose or other conduit or path or part thereof referred to herein can be defined as an integral and/or one-piece construction with the bowl 14 and/or pedestal 18 and/or tank 54 of the toilet, i.e., the conduit or path can be defined entirely or partly by an opening defined in the toilet 10, itself, and need not be a separate hose, pipe, etc. although such separate hoses, pipes, and other conduits can be used.

FIG. 5 shows one example of a suitable electrical circuit for the toilet 10. The battery and/or power supply 102, 106 is connected to a relay 156 that is connected to the exhaust blower 98 and that selectively supplies electrical power to the exhaust blower 98 from the power source 102,106. In particular, the relay 156 supplies electrical power to the exhaust blower 98 only when at least one of the seat switches 134, 136 (or the single seat switch 134,136 if only one is used) is closed. When at least one of switches 134,136 is closed, the relay 156 changes from its normally open (non-conducting) state to a closed (conducting) state to conduct electrical power from the source 102,106 to the blower 98. The switches 134, 136 (and switches 137,138 described herein) can be in a low voltage/amperage path (e.g., at or below a predeterminable limit (volts, amps, etc.) to maximize their life and prevent burn-out of same as could occur without the relay. In FIG. 5, the switches 134,136 can be replaced by the single switch 138 as described above such that the switch 138 energizes the relay 156 when closed/active (conductive). In such case, the schematic is identical to FIG. 5 except that one of the switches 134,136 is eliminated and the other remaining switch 134,136 is renumbered as the switch 138. The switches 134,136 (or 138) can be replaced by a timer switch 137 as described below with reference to FIG. 6 that connects the blower 98 to the source of electrical power 102,106 for only a select, preset time period.

The timer switch 137 can be implemented as shown in FIG. 6. FIG. 6 particularly shows a timer switch circuit embodiment that utilizes a timer switch 137sw operatively connected between the relay 156 and the blower 98. The timer switch 137sw can be located any suitable location on the toilet as described above for the switch 137/138 or on the bowl 14 or pedestal 18 at a central front location (opposite the tank 54) in a location that will be located between the legs of a user seated on the toilet seat 38. The timer switch 137sw is manually activated and when activated from its normally open (non-conducting) state to a closed (conducting) state it energizes a coil of the relay 156 which causes the relay 156 to change from its normally open (non-conducting) state to its closed (conducting) state to operably connect the power source 102,106 to the blower 98 such that the blower 98 is active when the relay 156 is “on” or conductive. The timer switch 137sw includes an electronic timer 137t that maintains the switch 137sw in its conductive “on” state for a select time period that can be preselected such as between 5 to 10 minutes (e.g., 6 minutes or 7 minutes) or more or less after which select time period the timer 137t causes the switch 137sw to change state from its conducting state to its open or non-conducting state such that the relay coil 156 is deenergized when the switch 137sw is non-conductive and the relay 156 then returns to its normally open (non-conductive) state. During the select time period (or after the select time period) when the switch 137 is conductive, a user can manually activate the switch 137sw again to reset the timer 137t and re-start the select time period such that the switch 137sw continues to be or is again conductive to energize the relay and thus the blower 98.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A toilet for exhausting odorous air therefrom, comprising:
a bowl;
a trap;
a self-contained ventilation system;
a water tank;
a water tank lid;
a water supply line;
said bowl has a rim therearound wherein said bowl communicates with said rim;
said bowl is for receiving human waste that produces the odorous air;
wherein said trap is for communicating the contents in said bowl with a drain conduit so as to provide a passageway from said bowl to an associated drain stack;
said ventilation system includes an exhaust blower having a blower inlet and a blower outlet; said blower inlet in communication with air space between the contents in said bowl and said rim; said blower outlet in communication with said drain conduit downstream from said trap;
said exhaust blower further including a check valve between said blower outlet and said drain conduit for preventing the odorous air from flowing upstream from the associated drain stack into said blower outlet;
said check valve is biased to a closed position and when closed blocks the odorous air from said drain conduit to said blower outlet;
said check valve is selectively moved to an open position when said exhaust blower is activated at a pressure at said blower outlet thereby opening said check valve to allow odorous air to flow from said blower outlet to said drain conduit;
said water tank incorporates an air admittance valve so as to assist the gravitational release of water during flush.

2. The toilet as defined in claim 1, further comprising a conduit within said water tank that extends to an open space between a water line in said water tank and said water tank lid, wherein said conduit is connected to said blower inlet.

3. The toilet as set forth in claim 1, further comprising a seal between the water tank and the water tank lid.

4. The toilet as defined in claim 1, wherein said pressure at which said check valve opens includes a predeterminable PSI.

5. The toilet as defined in claim 1, further comprising at least one pressure sensitive switch; wherein said pressure sensitive switch extends operatively upwardly from said rim of said bowl; and wherein said pressure sensitive switch is activated when the user sits on said bowl, and when activated, causes said exhaust blower to activate.

6. The toilet as defined in claim 5, wherein said pressure sensitive switch deactivates said blower in response to the user removing pressure from said seat.

7. The toilet as defined in claim 1, further comprising a timer switch; wherein said timer switch is configured for being manually activated by the user, and when activated, causes said exhaust blower to activate for a select time period.

8. A toilet for exhausting odorous air therefrom, comprising:
a bowl;
a trap;
a self-contained ventilation system;
a modified air pass-through hinge/seat;
a water supply line;
said bowl has a rim therearound wherein said bowl communicates with said rim;
said bowl is for receiving human waste that produces the odorous air;
wherein said trap is for communicating the contents in said bowl with a drain conduit so as to provide a passageway from said bowl to a drain stack;
said modified air passthrough hinge/seat is located above said rim and in communication with air space between the contents in said bowl and said rim;
said ventilation system includes an exhaust blower having a blower inlet and a blower outlet, wherein said blower inlet is connected to said modified air passthrough hinge/seat;
said blower inlet is connected to said modified air passthrough hinge/seat via (hoses, piping porcelain etc.);
said blower outlet in communication with said drain conduit downstream from said trap;
said exhaust blower further including a check valve between said blower outlet and said drain conduit for preventing the odorous air from flowing upstream from said drain stack into said blower outlet;
said check valve is spring biased to a closed position and when closed blocks the odorous air from said drain conduit to said blower outlet;
said check valve is selectively biased to an open position when said exhaust blower is activated at a pressure at said blower outlet thereby opening said check valve to allow odorous air to flow from said blower outlet to said drain conduit.

9. A method for exhausting odorous air from a toilet, comprising:
selectively operating a self-contained ventilation system in communication with air space in a toilet bowl;
wherein said bowl is in communication with a water tank and a water supply line;
wherein said bowl is further in communication with a drain conduit;
said drain conduit extending from a trap at one end and extending to a drain stack at another end;
said bowl has a rim therearound wherein said bowl communicates with said rim;
said bowl is for receiving human waste that produces the odorous air;
communicating the contents in said bowl through said trap and into said drain conduit so as to provide a passageway from said bowl to a drain stack;
said ventilation system includes an exhaust blower having a blower inlet and a blower outlet;
said blower inlet in communication with air space above the contents in said bowl;
said blower outlet in communication with said drain conduit downstream from said trap;
said rim including a seat and a pressure sensitive switch thereunder;
activating said switch for initial powering of said blower in response to a user sitting on said seat;
said pressure sensitive switch deactivates said blower in response to the user removing pressure from said seat.

10. The method of claim 9, further comprising:
said exhaust blower further including a check valve between said blower outlet and said drain conduit for preventing the odorous air from flowing upstream from said drain stack into said blower outlet;
said check valve is spring biased to a closed position and when closed blocks the odorous air from said drain conduit to said blower outlet; and,
said check valve is selectively biased to an open position when said exhaust blower is activated at a pressure at said blower outlet thereby opening said check valve to allow odorous air to flow from said blower outlet to said drain conduit.

11. A method for exhausting odorous air from a toilet, comprising:
selectively operating a self-contained ventilation system in communication with air space in a toilet bowl;
wherein said bowl in communication with a water tank and a water supply line;
wherein said bowl in further communication with a drain conduit;
said drain conduit extending from a trap at one end and extending to a drain stack at another end; said bowl has a rim therearound wherein said bowl communicates with said rim;
said bowl is for receiving human waste that produces the odorous air;
communicating the contents in said bowl through said trap and into said drain conduit so as to provide a passageway from said bowl to a drain stack;
said ventilation system includes an exhaust blower having a blower inlet and a blower outlet; said blower inlet in communication with air space above the contents in said bowl;
said blower inlet is connected to said modified air passthrough hinge/seat via (hoses, piping porcelain etc.);
said blower outlet in communication with said drain conduit downstream from said trap; said rim including a seat and a pressure sensitive switch thereunder;
activating said switch for initial powering of said blower in response to a user sitting on said seat;
said pressure sensitive switch deactivates said blower in response to the user removing pressure from said seat.

12. The method of claim 11, further comprising:
said exhaust blower further including a check valve between said blower outlet and said drain conduit for preventing the odorous air from flowing upstream from said drain stack into said blower outlet;
said check valve is spring biased to a closed position and when closed blocks the odorous air from said drain conduit to said blower outlet; and,
said check valve is selectively biased to an open position when said exhaust blower is activated at a pressure at said blower outlet thereby opening said check valve to allow odorous air to flow from said blower outlet to said drain conduit.

13. A ventilated toilet comprising:
a bowl comprising a rim including a rim conduit with a plurality of flush apertures that open to the bowl;
a drain conduit that communicates with a waste outlet of the bowl and that includes a stack outlet for communicating with an associated waste stack;
a trap located in the drain conduit between the waste outlet of the bowl and the stack outlet of the drain conduit for containing liquid that blocks airflow through said drain conduit;
a neck located adjacent the rim of the bowl, said neck including a neck conduit in communication with the rim conduit;
a water tank connected to the neck and including an internal space for holding water that is in communication with the neck conduit, wherein said tank is adapted to hold a maximum operational water level during use;
a lid that covers an open upper end of the tank;
flush valve located in the tank that selectively opens to allow flow of water from the internal space of the tank to the neck conduit;
an overflow tube in communication with the neck conduit and including an open upper end that is located above said maximum operational water level of the internal space of the tank;
an exhaust blower comprising a blower inlet and a blower outlet;
a blower inlet conduit that connects said blower inlet to said internal space of said tank, wherein said blower inlet conduit comprises an open upper end that is located above the maximum operational water level such that said open upper end of said blower conduit is spaced-apart from said open upper end of said overflow tube;
said blower outlet in communication with said drain conduit downstream from said trap between said trap and said stack outlet;
a check valve located between said blower outlet and said drain conduit and adapted to selectively open when said exhaust blower is activated.

14. The ventilated toilet as set forth in claim 13, further comprising:
a seal located between said lid and said upper end of the tank;
an air admittance valve connected to the tank or lid and that selectively opens during a flush of the toilet to allow airflow into the internal space of the from an atmosphere located external to the tank.

15. The ventilated toilet as set forth in claim 13, further comprising a timer switch circuit adapted to connect said blower to a power source for a select timer period to activate said blower for only said select time period after said timer switch circuit is activated, wherein said timer switch circuit comprises a timer switch to be activated by a user.

16. The ventilated toilet as set forth in claim 15, wherein said timer switch circuit comprises a timer switch and a relay operatively connected to said timer switch and to said power source such that said relay is adapted to connect said power source to said blower when said timer switch is in a conductive state.

17. The ventilated toilet as set forth in claim 15, wherein said timer switch of said timer switch circuit is located on a front of the bowl or on the front of a pedestal base so as to be located in front of and between the legs of a user seated on a toilet seat supported on said rim of said toilet bowl.

18. The ventilated toilet as set forth in claim 13, wherein said open upper end of said blower inlet conduit is selectively extendable toward and retractable away from said open upper end of said overflow tube to vary an open distance between said open upper end of said blower inlet conduit and said open upper end of said overflow tube.
